(19) United States
(12) Patent Application Publication
(10) Pub. No.: US 2009/0067966 A1
(43) Pub. Date: Mar. 12, 2009

(54) TIRE SUPPORT APPARATUS

(76) Inventor: Isreal Hicks, Arlington, WA (US)

Correspondence Address: BLACK LOWE & GRAHAM, PLLC, 701 FIFTH AVENUE, SUITE 4800, SEATTLE, WA, 98104, US

(21) Appl. No.: 12/170,996

(22) Filed: Jul. 10, 2008

Related U.S. Application Data
(63) Continuation-in-part of application No. 10/081,928, filed on Feb. 20, 2002.
(60) Provisional application No. 60/270,139, filed on Feb. 20, 2001.

(51) Int. Cl. B62D 43/04

(52) U.S. Cl. 414/463

(57) ABSTRACT

A tire hanger that is rapidly mountable and dismountable from a substantially horizontal hoist member of a vehicle-lifting device or hoist. The tire hanger includes a hoist engagement end and a tire engagement end. The hoist engagement end is configured for the rapid mounting and dismounting to the hoist member and is advantageously achieved without the use of fasteners to secure the tire hanger to the hoist member. Other embodiments provide for the tire engagement end to be pivotable from the hoist engagement end so that the tire hanger may be rotated from a stowed position to a deployed position while remaining in place on the hoist member. In yet other embodiments, a shield may be placed over the tire engagement end to protect workers from being jabbed from a deployed tire hanger that is not holding a tire.

### CROSS REFERENCE TO RELATED APPLICATIONS

This application is a continuation-in-part of and incorporates by reference in its entirety U.S. patent application Ser. No. 10/081,928 filed Feb. 20, 2002, that in turn claims priority to and incorporates by reference in its entirety U.S. Provisional Patent Application Ser. No. 60/270,139 filed Feb. 20, 2001. All applications herein incorporated by reference in their entirety.

### FIELD OF THE INVENTION

An embodiment of the present invention relates to a tire-changing aid.

### BACKGROUND OF THE INVENTION

Workers in automotive repair stores, tire shops and local garages change tens of millions of vehicle tires every year. Worn tires are constantly being changed to prevent unsafe driving conditions. Similarly, in regions having varying road conditions due to the climate, vast numbers of tires are changed to properly equip a vehicle with the best tires for the seasonal road conditions.

Under current commercial practices, each time an individual changes a vehicle's tire, they are subjecting themselves to a variety of potential injuries due to the weight of the tire and the necessary body contortions required to move the tire from the vehicle to the ground, or vice versa. Typically, the vehicle is driven onto a hydraulic hoist and then the vehicle is lifted some height from the ground wherein the tires are removed from the vehicle and placed upon the ground. As the vehicle may be several feet from the ground, the individual is often required to bear the weight of the tire for a considerable time while placing the tire on the ground. Further, the transitory nature of tires placed upon the ground in a workspace is a safety hazard.

### SUMMARY OF THE INVENTION

A tire changing aid to promote the ergonomic handling of automobile tires during tire changing or other tire related procedures. The tire changing aid is a tire hanger that is rapidly mountable and dismountable from a substantially horizontal hoist member of a vehicle-lifting device or hoist. The tire hanger serves as a tire support apparatus that provides for rapid mounting and dismounting to the hoist member and is advantageously achieved without the use of fasteners to secure the tire hanger to the hoist member. This permits the easy repositioning of the tire hanger along the hoist member at a user-selected position to achieve the optimal ergonomic location for tire placement without having to endure the inconvenience and suffer the time loses associated with fastening and unfastening tire support devices encumbered with fasteners for securing. Upon placing or engaging the tire with the tire engagement end, the tire hanger is secured to the hoist from the weight of the tire bearing upon the tire hanger, thereby self-securing the user-selected tire hanger location.

Other embodiments include a tire engagement end that is pivotable from the hoist engagement end so that the tire hanger may be rotated from a stowed to a deployed position while in place on the hoist member. In yet other embodiments, a shield may be placed over the tire engagement end to protect workers from being jabbed from a deployed and unused tire hanger.

### BRIEF DESCRIPTION OF THE DRAWINGS

Illustrative and alternative embodiments of the present invention are described in detail below with reference to the following drawings.

FIG. 1 illustrates a single piece tire-hanging device;

FIG. 2 illustrates a multiple piece tire-hanging device having a pivotable member;

FIG. 3 illustrates a perspective view of stowed and deployed single and multiple piece tire hanging devices;

FIG. 4A illustrates a tire being held by the single or multiple piece tire handing devices;

FIG. 4B is a cross section view of FIG. 4A;

FIG. 5 illustrates a bottom perspective internal view of a deployed tire hanging device;

FIG. 6 illustrates FIG. 2 embodiment having a protective shield;

FIG. 7 illustrates embodiments of a shield covered tire hanger; and

FIG. 8 illustrates a top perspective and internal view of the multiple piece tire-hanging device 40 in a deployed state.

### DETAILED DESCRIPTION OF THE PARTICULAR EMBODIMENTS

Figures described below illustrate particular embodiments for a tire hanger. The particular embodiments include a tire hanger apparatus that is rapidly mountable and dismountable from a substantially horizontal hoist member of a vehicle-lifting device or hoist. The tire hanger includes a hoist engagement end and a tire engagement end. The hoist engagement end is configured for the rapid mounting and dismounting to the hoist member and is advantageously achieved without the use of fasteners to secure the tire hanger to the hoist member. Other embodiments provide for the tire engagement end to be pivotable from the hoist engagement end so that the tire hanger may be rotated from a stowed position to a deployed position while remaining in place on the hoist member. In yet other embodiments, a shield may be placed over the tire engagement end to protect workers from being jabbed from a deployed tire hanger that is not holding a tire.

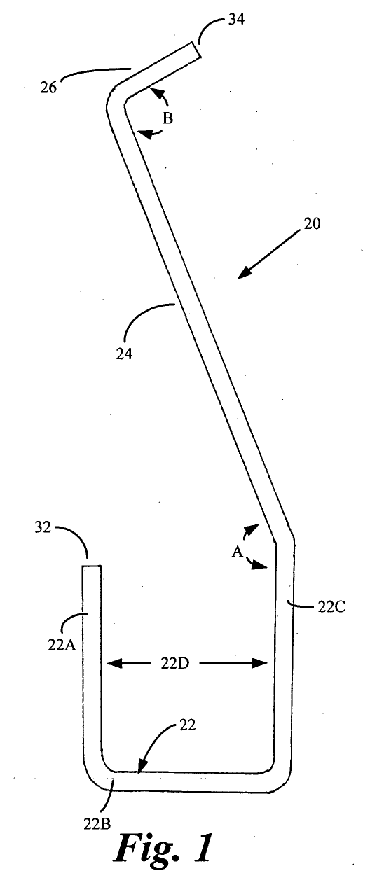

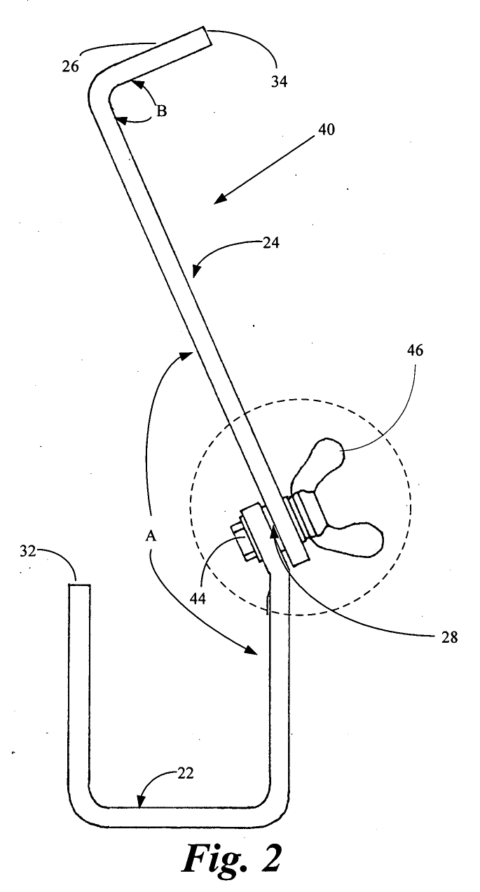

The particular embodiments are generally directed to single and multiple piece tire hangers shown in FIGS. 1 and 2 below that are adjustably engagable with a horizontal member of an automotive lifting device or hoist. This adjustable engagability allows the ergonomic handling of automobile tires by a worker to be executed during mounting and dismounting procedures from a vehicle held by the automotive lifting device.

A more specific description of the particular embodiments include a tire hanger for holding a tire that has a bar shaped or flattened bar shaped appearance. The bar or flattened bar shaped tire hanger is configured to removably engage a substantially horizontal support member of a vehicle hoist at a user-selected position so that tires may be ergonomically handled during tire changing or other automotive related procedures. The bar or flattened bar device includes a first end that is arranged to be mounted by at least partially circumscribing the horizontal support member without the need for fasteners. The partial circumscribing is achieved by the first end having a substantially U-shaped configuration that is complimentarily shaped to the cross sectional profile of the substantially horizontal support member, wherein three sides of the U-shaped first end has sides proportionally larger than the three comparable sides of the horizontal support member to which the U-shaped sides engage. The three sides of the U-shaped first end define a composite length that is larger than the comparable 3-sided composite length of the cross section of the horizontal support member. The U-shaped first end includes a gap that that readily accommodates slipping on and slipping off of the U-shaped first end to the horizontal support member so that the U-shaped first end may be readily wrapped around the complementarily shaped horizontal support member. The proportional length of the three-sided the U-shaped first end is matched side for side with the length of the three-sides of the horizontal support member so that on-and-off engagement is achieved without the tire hanger's first end from sliding off the horizontal support member.

The tire hanger also includes a second end having a hook configuration to engage a wheel; preferably the axle hole of a wheel hub in alternate embodiments. A middle section is disposed between the first end and the second end, with the middle section having a length suitable for engaging the hook configuration with the wheel. Upon engaging a tire with the second end, the weight of the tire assists in securing the first end to the horizontal support member. In other embodiments, the tire hanger may include a pivot connection to allow the second end to pivot from the first end at an angle between acute and obtuse to the linear axis of the first end. The pivot connection may be adjustably tightened to have the second end in a stowed position, or positioned substantially linear with the axis of the first end to more readily engage and hold a tire. In yet other embodiments the second end may include a protective cover to shield sharp edges or the tip of the second end to foster worker safety.

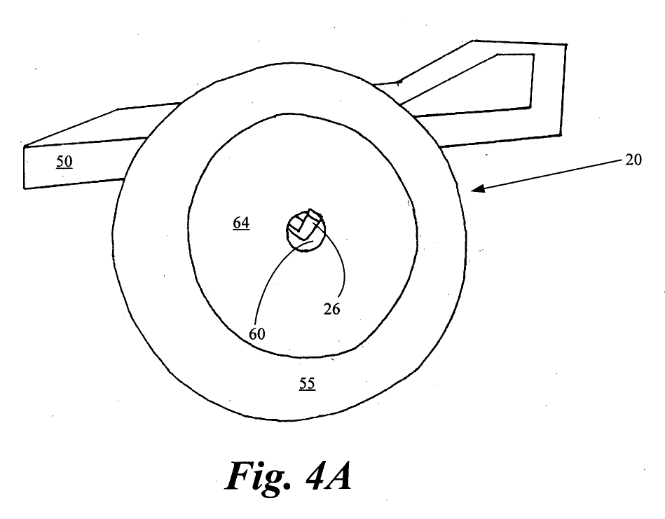

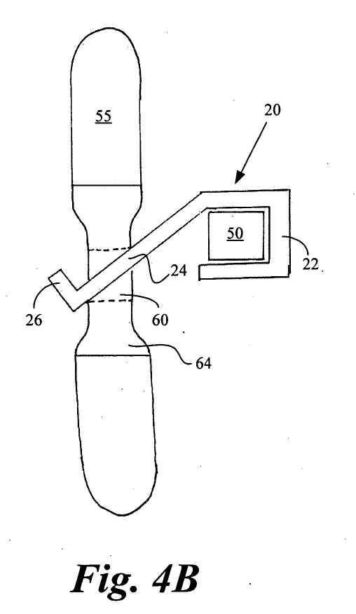

FIG. 1 discloses a single piece tire-hanging device 20. The tire hanging device 20 includes a hoist engagement end or hoist wrap section 22, a middle or elongated section 24, and a tire engagement end or tire hanging section 26. The hoist wrap section 22 is generally U-shaped structure that is designed to fit over the horizontal member of the automobile lift, and includes a first side 22A, a second side 22B, and a third side 22C. A gap 22D defines the space through which the cross sectional portion of the hoist member passes through to allow the hoist wrap section 22 to slidably anchor. In general the first, second, and third side 22A,B,C are larger than and retain the same proportionate side-to-side-to-side ratio to the companion three sides of the horizontal hoist member (see FIG. 4B below) to which sides 22A,B,C wrap around and slidably engage. A free end 32 portion of the hoist wrap section 22 is designed to allow a tire hanging device 20 to be easily attached to, and removed from the automotive lift. An obtuse angle A between the third side 22C and the elongated middle section 24 defines the downward slope of the tire hanger 20. A generally acute to a substantially right angle B defines the upward angle of the hook of the tire hanging section 26 to engage the axle hole of a wheel hub to retain a positioned tire. In alternate embodiments the angle B may be slightly obtuse. The tire hanging section 26 is connected at the angle B to the elongated section 24. The tire hanging section 26 generally consists of a straight member of sufficient length to hold an automotive tire while the tire-hanging device 20 is being employed. The tire hanging section 26 employs an open end 34, which is inserted through the axle hole of an automotive wheel thereby serving as the holding mechanism for the tire.

In alternate embodiments, the tire-hanging device 20 may comprise a metal construction of flattened steel having an approximate 0.35-inch thickness. The approximate dimensions of U-shaped hoist wrap section 22 first side 22A may be 5.2 inches, the second side 22B may be 4.3 inches, the third side 22C may be 6.0 inches, and the gap 22D may be approximately 3.6 inches. The angle A between the third side 22C and the elongated middle section 24 may be approximately 160 degrees, with an approximate range varying between 145 to 175 degrees. The length of the elongated middle section 24 may be 10.5 inches. The angle B between the elongated middle section 24 and the tire hanging section 26 may be approximately 110 degrees, with an approximate range spanning between 85 degrees to 125 degrees.

FIG. 2 illustrates a multiple piece tire-hanging device 40 having two overlapping members that articulated about a pivotable joint 42 generally denoted by the dashed circle. The device 40 includes the same elements described for device 20, plus the pivotable joint 42. The elongated middle section 24 is subdivided near the end of third side 22C through which a bolt 44 transits an orifice (not shown) of each overlapping member that is tightened or loosened via wing nut 46. The pivotable joint 42 allows articulation so that the tire hanging section 26 may be freely rotated from the hoist section 22 to provide workers a stowed and deployed position while the tire-hanging device 40 placed to the hoist member. The bolt 42 may be a pin and the wing nut 46 another locking or clamping device. Further, a hinge (not shown), such as a wrap hinge is employable with this device to rotate the device in a vertical manner. Dimensions of the multiple piece tire-hanging device 40 may be similar to the tire-hanging device 20.

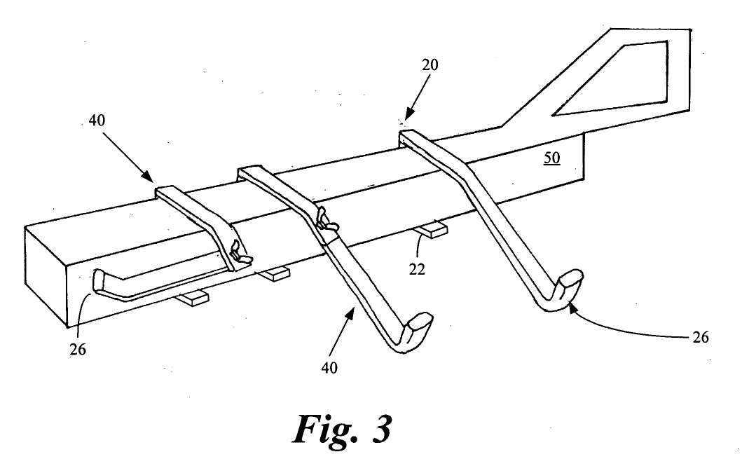

FIG. 3 illustrates a perspective view of the tire hanging devices 20 and 40 placed on a substantially horizontal hoist member 50. The single piece 20 is always in a deployed position and extends substantially 90 degrees to the long axis of the hoist member 50. The multiple piece tire hanging devices 40 are shown in stowed and deployed positions. On the leftmost side of the hoist member 50 the multiple piece device 40 is shown with an L-shaped configuration in which the elongated section 24 and tire hanging section 26 are substantially parallel with the long axis of the hoist member 50. The middle located multiple device 40 is shown in the deployed state in which the elongated section 24 and tire hanging section 26 are substantially perpendicular with the long axis of the hoist member 50.

As depicted in FIG. 3, the hoist wrap section 22 may assume different lengths of the first, second, third side and gap 22A, B, C, and D to slidably and proportionately accommodate the dimensions of horizontal hoist member 50. In other embodiments, should the cross-sectional profile of the hoist member 50 be a shape other than substantially square to rectangular, for example a triangle shape, then the shape, the side dimensions, and the number of sides of the hoist wrap section 22 may be configured to slidably and proportionately accommodate the cross-sectional shape and dimensions of the hoist member 50.

FIG. 4A is a perspective view of the tire-hanging device 20 or 40 engaged with and holding an automotive tire. The picture illustrates the tire hanging section 26 extending through the axel hole in the automotive wheel. Further, the upwardly directed tire hanging section 26 prevents the tire from falling from the free end 34 of the tire hanging section 26.

FIG. 4B is a cross sectional view of the FIG. 4A and illustrates the single member tire hanging device 20 holding a tire 55 via axle hole 60 of wheel hub 64. Here the elongated section 24 is shown having sufficient length to hold the tire at a distance from the hoist member 50 and being restrained by the hook shaped tire engagement end 26.

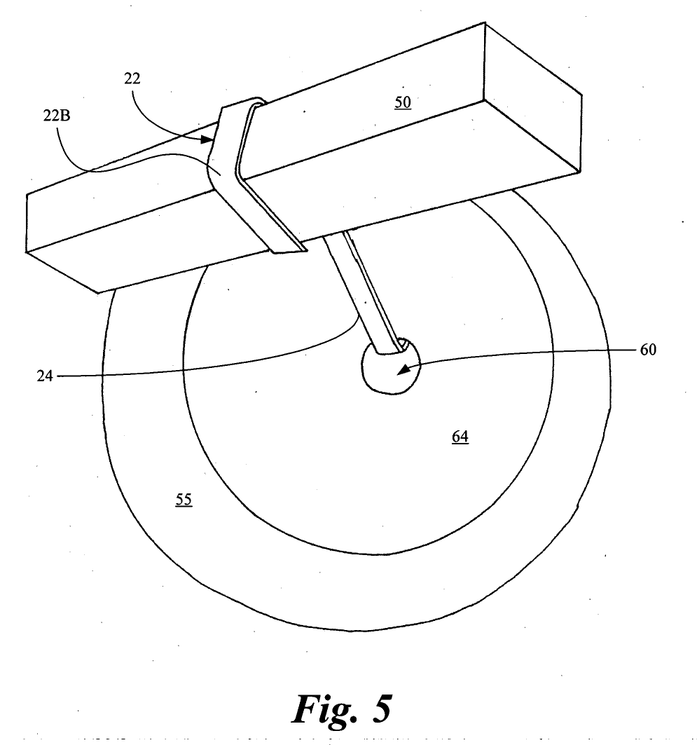

FIG. 5 illustrates an internal angle beneath the hoist member 50 looking toward the inner side of the wheel hub of the tire-hanging device 20, being employed to hold an automotive tire on an automotive lifting device. As can be seen in this photo the generally U-shaped hoist wrap section 22, extends around the rectangular shaped horizontal arm 50 of the lifting mechanism thereby locking the tire hanging device 20 in position. Further, as can be seen in this illustration the tire-hanging device 20 may be slidably locatable anywhere along the horizontal lifting arm. Likewise, dependant upon the length of the elongated section 24 engaging with the axle hole 60 of hub 64 and the relative angles of the tire-hanging device 20, the tire 55 may be held at a variety of locations relative to the ground, hoist, and vehicle.

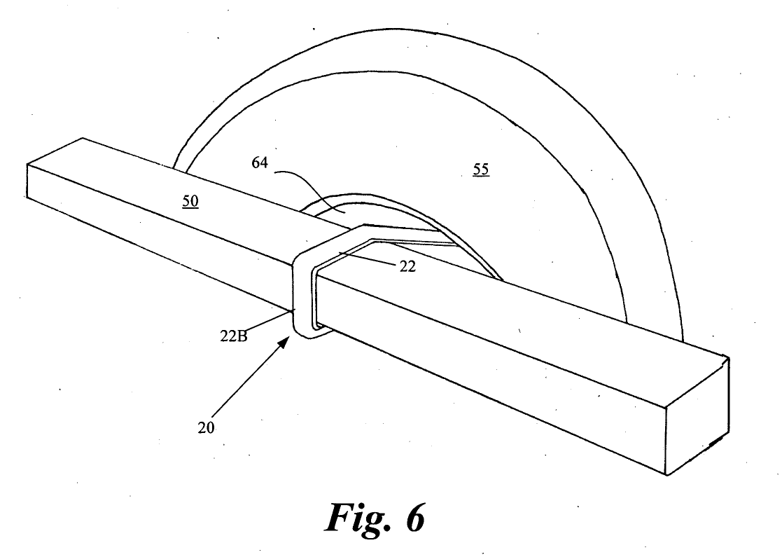

FIG. 6 illustrates an internal view above the hoist member 50 of the tire-hanging device 20 holding an automotive tire from the horizontal member 50 of the automotive lifting device. As can be seen the automotive tire 55 is maintained at a height that is optionally convenient for the automotive mechanic. As such, the mechanic is not required to do excessive bending, twisting, or lifting while moving tires to and from the vehicle.

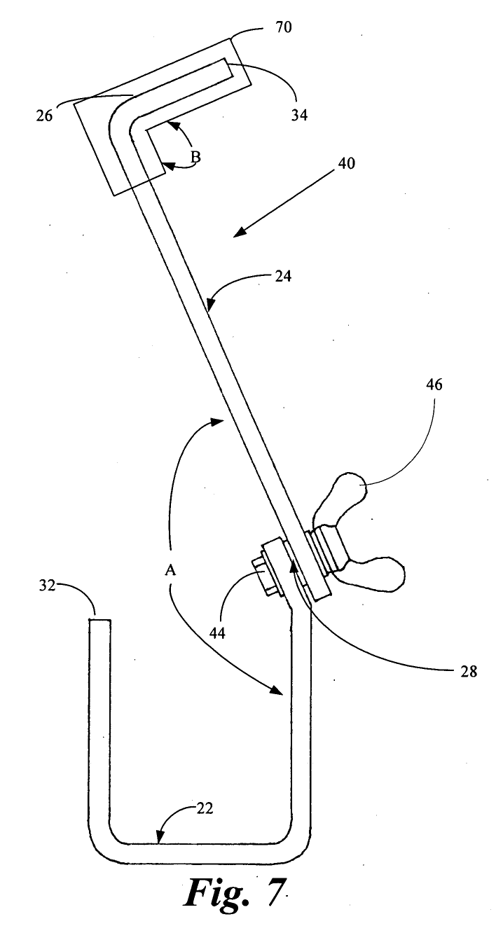

FIG. 7 illustrates the device 40 formed from two pieces, having an overlapping joint between the two pieces, and further having a protective sock or shield 70 to minimize workers from being jabbed by sharp edges of the tire hanging section 26. The shield may be constructed of plastic or heavy fabric material to cover the sharp edges.

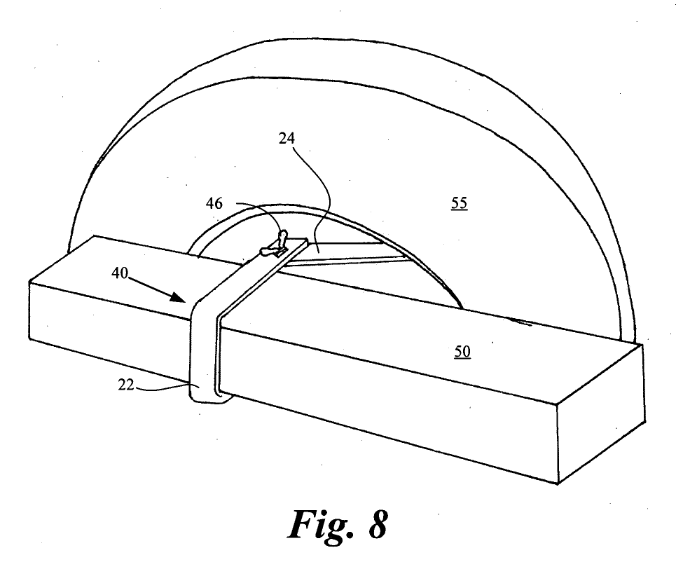

FIG. 8 illustrates an internal view above the hoist member 50 of the tire-hanging device 40 in the deployed state holding the automotive tire 55 from the horizontal member 50 of the automotive lifting device. Here the wing nut 46 is shown tightened to deploy the elongated middle section 24 to be substantially collinear with the third side 22C of the hoist section 22

It is within the scope of this invention that the device is constructed to varying sizes dependent upon the employment environment of the device. Conceptually, a larger, more rigid device is employable with heavier tires and a smaller, more compact version for light automotive concerns. Further, it is anticipated that the device, in its rotatable form, is rotatable about a single or multiple axes. Likewise, the material choice of the device is diverse. FIGS. 1-8 illustrate a device manufactured from steel or steel based alloy. However, it is anticipated that the device is capable of being manufactured from any other metallic material or alloy, for example, aluminum and titanium. Further, it is also anticipated that many other materials are capable of being used, for example, hard plastics or polymer based materials. Additionally, it is anticipated that the device shall be painted, colored, or died a bright color so as to improve the safety of the working environment by making the device readily visible. This device is intended to make it safer and more convenient for automotive mechanics and the like to change or otherwise remove and replace tires on automotive vehicles. The device allows the tires to be removed from the vehicle and stored at the workmen's upright height. This prevents the worker from having to repeatedly bend over and lift heavy objects from the ground to the work height at the vehicle, or vice versa, thereby increasing safety and comfort of the workers.

While the preferred embodiment of the invention has been illustrated and described, as noted above, many changes can be made without departing from the spirit and scope of the invention. For example, the more than one pivot connection in the middle section may be used in alternate embodiments. The protective shield or sock cover may be brightly colored or fitted with an audible alarm when left in place in the deployed position but not holding a tire. Accordingly, the scope of the invention is not limited by the disclosure of the aforementioned exemplary embodiments. Instead, the invention should be determined entirely by reference to the claims that follow.

The embodiments of the invention in which an exclusive property or privilege is claimed are defined as follows:

1. A tire hanger for holding a tire comprising:
a device configured to removably engage a horizontal support member of a vehicle hoist at a user-selected position, the device having:
a first end arranged to be mounted by at least partially circumscribing the horizontal support member without the need for fasteners;
a second end having a hook configuration to engage a wheel; and
a middle section disposed between the first end and the second end, the middle section having a length suitable for engaging the hook configuration with the wheel,
wherein the tire once engaged with the second end secures the first end to the horizontal support member.

2. The tire hanger of claim 1, wherein the first end is in the form of a U-shape.

3. The tire hanger of claim 2, wherein the send end engages with the axle opening of an automobile wheel hub.

4. The tire hanger of claim 3, wherein the middle section includes a pivot connection to allow the second end to pivot from the first end at an angle between acute and obtuse to the linear axis of the first end.

5. The tire hanger of claim 3, wherein the second end includes a protective cover that envelops the second end.
